(19) United States
(12) Patent Application Publication
(10) Pub. No.: US 2016/0239834 A1
(43) Pub. Date: Aug. 18, 2016

(54) METHOD AND APPARATUS FOR REQUESTING ACCOUNT TRANSFER

(71) Applicant: Xiaomi Inc., Beijing (CN)

(72) Inventors: Mingze SUN, Beijing (CN); Yuanyuan HUANG, Beijing (CN); Yang ZHANG, Beijing (CN)

(73) Assignee: Xiaomi Inc.

(21) Appl. No.: 15/044,256

(22) Filed: Feb. 16, 2016

(30) Foreign Application Priority Data
Feb. 16, 2015 (CN) 201510083656.9

(51) Int. Cl. G06Q 20/38

(52) U.S. Cl. CPC G06Q 20/38

(57) ABSTRACT

A method for requesting an account transfer for use in a terminal, includes: displaying a contact information page of a first contact, wherein the contact information page contains a transfer option corresponding to a first account of the first contact; when receiving a trigger instruction triggering the transfer option, acquiring an account identification (ID) of the first account, information on a local login account, and transfer information input by a user; and sending, to a server, a transfer request carrying the account ID of the first account, the information on the local login account, and the transfer information, for the server to perform transfer indicated by the transfer information from the local login account to the first account.

### CROSS-REFERENCE TO RELATED APPLICATIONS

This application is based upon and claims priority to Chinese Patent Application No. 201510083656.9, filed on Feb. 16, 2015, the entire contents of which are incorporated herein by reference.

### TECHNICAL FIELD

The present disclosure generally relates to the field of computer technology and, more particularly, to a method and apparatus for requesting an account transfer.

### BACKGROUND

With the development of mobile terminal technology, a mobile terminal has found increasingly wide application and has become an indispensable tool for daily life. Besides mobile communication, multiple other functions, such as Internet-based video watching, information search, and transfer, may also be implemented with a mobile terminal. A transfer function is one of the most important functions in daily life.

Conventionally, an application with a transfer function, such as Alipay, is installed on a mobile terminal. During transfer, a user may start the Alipay application, click on a transfer option in the Alipay application, input an account name of a target account, and then perform a transfer operation.

### SUMMARY

According to a first aspect of the present disclosure, there is provided a method for requesting an account transfer for use in a terminal, comprising: displaying a contact information page of a first contact, wherein the contact information page contains a transfer option corresponding to a first account of the first contact; when receiving a trigger instruction triggering the transfer option, acquiring an account identification (ID) of the first account, information on a local login account, and transfer information input by a user; and sending, to a server, a transfer request carrying the account ID of the first account, the information on the local login account, and the transfer information, for the server to perform transfer indicated by the transfer information from the local login account to the first account.

According to a second aspect of the present disclosure, there is provided an apparatus for requesting an account transfer, comprising: a processor; and a memory configured for storing instructions executable by the processor, wherein the processor is configured to: display a contact information page of a first contact, wherein the contact information page contains a transfer option corresponding to a first account of the first contact; when receiving a trigger instruction triggering the transfer option, acquire an account identification (ID) of the first account, information on a local login account, and transfer information input by a user; and send, to a server, a transfer request carrying the account ID of the first account, the information on the local login account, and the transfer information, for the server to perform transfer indicated by the transfer information from the local login account to the first account.

According to a third aspect of the present disclosure, there is provided a non-transitory computer-readable storage medium having stored therein instructions that, when executed by a processor of a terminal, cause the terminal to perform a method for requesting an account transfer, the method comprising: displaying a contact information page f a first contact, wherein the contact information page contains a transfer option corresponding to a first account of the first contact; when receiving a trigger instruction triggering the transfer option, acquiring an account identification (ID) of the first account, information on a local login account, and transfer information input by a user; and sending, to a server, a transfer request carrying the account ID of the first account, the information on the local login account, and the transfer information, for the server to perform transfer indicated by the transfer information from the local login account to the first account.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for requesting an account transfer, according to an exemplary embodiment.

FIG. 2 is a schematic diagram illustrating a display interface, according to an exemplary embodiment.

FIG. 3 is a block diagram of an apparatus for requesting an account transfer, according to an exemplary embodiment.

FIG. 4 is a block diagram of an apparatus for requesting an account transfer, according to an exemplary embodiment,

FIG. 5 is a block diagram of an apparatus for requesting an account transfer, according to an exemplary embodiment.

FIG. 6 is a block diagram of an apparatus for requesting an account transfer, according to an exemplary embodiment.

FIG. 7 is a block diagram of a terminal, according to an exemplary embodiment.

Embodiments herein shown in the drawings are elaborated below. The drawings and the description are not intended for limiting the scope of the present disclosure in any way, but for illustrating the present disclosure to those skilled in the art by way of embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Inst ad, they are merely examples of apparatuses and methods consistent with aspects related to the invention as recited in the appended claims.

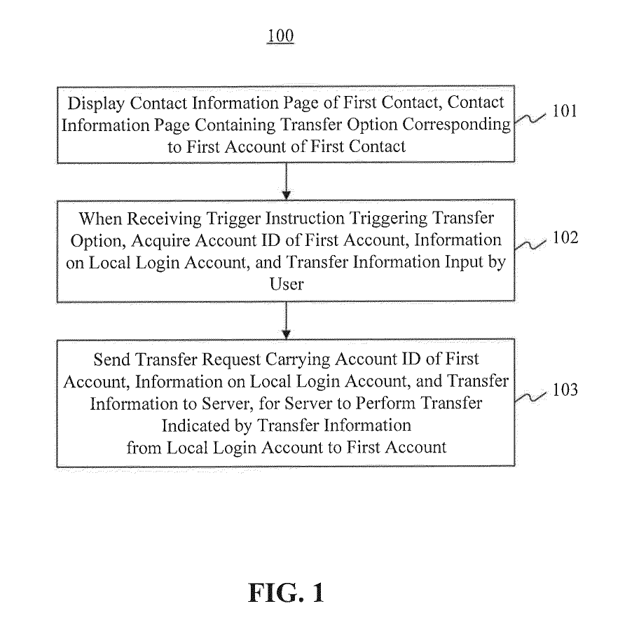

FIG. 1 is a flow chart of a method 100 for requesting an account transfer, according to an exemplary embodiment. For example, the method 100 may be used in a terminal provided with a contact list. The terminal may be a mobile terminal such as a mobile phone, a tablet computer, or the like.

In step 101, the terminal displays a contact information page of a first contact, the contact information page containing a transfer option corresponding to a first account of a first contact.

In exemplary embodiments, a user may in all an application with a transfer function on the terminal. The user may register an account with a server via the application and set an account password for the account, so as to perform transfer through the account. The user may also bind, through the application, the registered account with a funding account of the user such as a bank account). In addition, software corresponding to the transfer function may be installed in advance in the terminal to allow the terminal to support the transfer function. When the user needs to perform transfer, the user can click on an icon corresponding to a contact application in the terminal. The terminal thus receive a contact accessing instruction and display a local contact list.

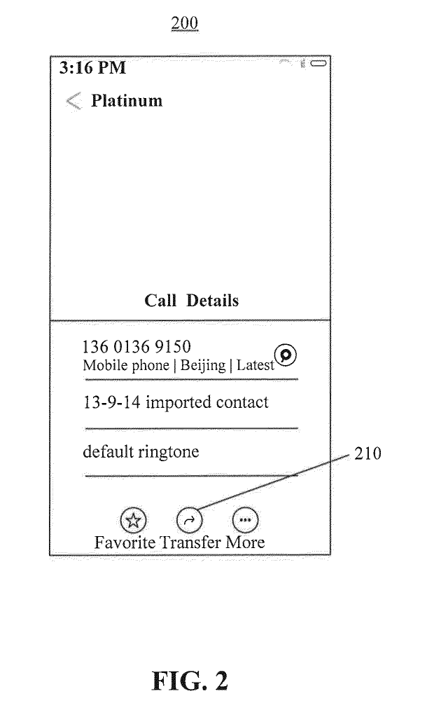

The user may select, e.g., click on, a contact to receive transfer in the contact list, to open the contact information page thereof. The contact information page may contain a transfer option corresponding to a first account of the contact to receive transfer. FIG. 2 is a schematic diagram of a display interface displaying a contact information page 200, according to an exemplary embodiment. As shown in FIG. 2, a name (e.g., “Platinum”) and a phone number (e.g., “136 0136 9150”) of the contact, as well as a ringtone setting button, a favorite button, and a transfer option 210, and the like, are displayed in the contact information page 200, such that the user can set the first account or perform transfer to the first account.

In addition, there may be various ways to trigger displaying, by the terminal, the transfer option of the first account. For example, the user may trigger displaying, by the terminal, the transfer option through a long press on the contact in the contact list. When the terminal detects that the user has been touching the contact in the contact list for a period of time longer than a preset period of time, a list of operation options pop up on the current display interface. The list of operation options may include a transfer option, as well as other options such as those for deleting a contact, blacklisting, and messaging. Alternatively, the user may trigger displaying, by the terminal, the transfer option by a sliding operation. The terminal displays the transfer option corresponding to the first account when detecting a sliding touch signal corresponding to the contact in the contact list.

In step 102, when the terminal receives a trigger instruction triggering the transfer option, the terminal acquires an account identification (ID) of the first account, information on a local login account, and transfer information input by a user.

The transfer information may include a transfer amount and account password of the local login account.

In exemplary embodiments, the user may click the transfer option on the contact information page of the contact to receive transfer. The terminal thus receives the trigger instruction triggering the transfer option and displays a transfer page. The user inputs, on the transfer page, the transfer information (including, e.g., the transfer amount and the account password of the local login account), and then clicks on an OK button. Accordingly, the terminal acquires the account ID of the first account, such as a phone number corresponding to the first account, the information on the local login account, the transfer amount, and the account password of the local login account input by the user. The information on the local login account may include an account ID of a funding account bound to the first account and an account ID of the local login account, such as a local phone number.

In exemplary embodiments, the user may select a desirable funding account as follows. A pre-stored list of funding accounts hound to the local login account is displayed. When a selecting instruction selecting a first funding account in the list of funding accounts is received, an account ID of the first funding account and the account ID of the local login account are acquired.

In exemplary embodiments, the information on the local login account includes the account ID of the local login account and the account ID of the first funding account selected by the user. The user may bind, via the aforementioned application, a registered account to multiple funding accounts of the user (such as bank accounts). After the user clicks on the transfer option on the contact information page of the contact to receive transfer, the terminal will display a transfer amount input page including an input box for inputting the transfer amount, The user inputs the transfer amount in the input box and clicks the OK button. The terminal will then display a funding account selection page including the list of funding accounts bound to the local login account. The list of funding accounts includes the account ID (such as a bank card number) of a funding account. The funding account selection page may also include the transfer amount and an input box for inputting the account password. The user inputs the account password of the local login account, and selects a desirable funding account (i.e., the first funding account) in the list of funding accounts. The terminal will thus receive the selecting instruction selecting the first funding account, and then acquire the transfer amount input by the user, the account password of the local login account, the account ID of the first account (such as the phone number corresponding to the first account), and the account ID of the local login account (such as the local phone number).

In exemplary embodiments, the terminal may automatically select a funding account as follows. More particularly, the terminal determines, from funding accounts bound to the local login account, a second funding account used most recently. An account ID of the second funding account and an account ID of the local login account are acquired.

In exemplary embodiments, the information on the local login account may include the account ID of the local login account and the account ID of the second funding account determined by the terminal. The user may perform transfer or make a payment using the local login account. The terminal records the transfer and payment conducted by the user. After the user makes a transfer or payment operation, the terminal acquires a time the user makes the transfer or payment (that is, the time a funding account is used), and acquires the funding account used in the operation. The terminal stores the funding account used in the operation and the time the funding account is used correspondingly to establish a correspondence between the funding account and the time the funding account is used. When the terminal receives the trigger instruction triggering the transfer option, the terminal searches for the correspondence for the funding account most recently used. The found funding account serves as the second funding account to be used. The terminal then acquires the account ID of the second funding account, the account ID of the first account, the account ID of the local login account, and the transfer information input by the user for subsequent processing.

In step 103, the terminal sends a transfer request carrying the account ID of the first account, the information on the local login account, and the transfer information to a server, such that the server performs transfer indicated by the transfer information from the local login account to the first account.

In exemplary embodiments, after the terminal acquires the account ID of the first account, the account ID of the local login account, the transfer amount, and the account password of the local login account input by the user, the terminal carries the acquired information in the transfer request, and sends the transfer request to the server. After the server receives the transfer request sent by the terminal, the server parses the transfer request to acquire the information therein, and further authenticates the account ID of the local login account and the account password of the local login account. After the local login account is authenticated, the server performs transfer according to the account ID of the first account and the transfer amount input by the user.

In exemplary embodiments, when the user selects a first funding account as a desirable funding account, the information on the local login account carried in the transfer request includes the account ID of the first funding account and the account ID of the local login account.

For example, after the terminal acquires the account ID of the first account, the information on the local login account including the account ID of the first funding account and the account ID of the local login account, and the transfer information, the terminal carries the acquired information in the transfer request and sends the transfer request to the server.

In exemplary embodiments, when the terminal automatically selects a second funding account, the information on the local login account carried in the transfer request includes the account ID of the second funding account and the account ID of the local login account.

For example, after the terminal acquires the account ID of the first account, the information on the local login account including the account ID of the second funding account and the account ID of the local login account, and the transfer information, the terminal carries the acquired information in the transfer request and sends the transfer request to the server.

In exemplary embodiments, the terminal may add a transfer option on a contact information page as follows. The terminal receives a transfer account adding request sent by the server. The transfer account adding request carries an account ID of a target account. The terminal adds a transfer option in a contact information page corresponding to the account ID of the target account.

For example, when a contact in the contact list has not registered an account with the server via the application with the transfer function, the contact information page corresponding to the contact displays no transfer option. When the contact needs to use the application, the contact installs the application with the transfer function on a terminal. When the contact registers an account with the server via the application, an account registration request will be sent to the server. The account registration request carries the account ID of the to-be-registered account (such as a phone number of the contact), the account password thereof and the like. The server receives the account registration request of the contact and registers the to-be-registered account. The server also searches locally for a contact list containing the contact, and then sends a transfer account adding request to the account owning the found contact list. The transfer account adding request carries the account ID of the contact (that is, the account ID of the target account). The terminal of the owner account then receives the transfer account adding request and adds a transfer option on the contact information page corresponding to the target account in the local contact list, such that a transfer to the target account can be performed later.

In the above-illustrated embodiment, the terminal displays a contact information page of a first contact, the contact information page containing a transfer option corresponding to a first account of the first contact. When the terminal receives a trigger instruction triggering the transfer option, the terminal acquires an account ID of the first account, information on a local login account, and transfer information input by a user. The terminal further sends a transfer request carrying the account ID of the first account, the information on the local login account, and the transfer information to a server, such that the server performs transfer indicated by the transfer information from the local login account to the first account. In this way, transfer to an account corresponding to a contact information page may be triggered through a transfer option on the contact information page without the need to manually input an account name of a target account by a user, thus improving transfer efficiency.

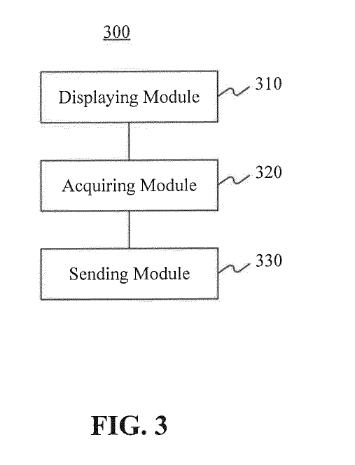

FIG. 3 is a block diagram of an apparatus 300 for requesting an account transfer, according to an exemplary embodiment. As shown in FIG. 3, the apparatus 300 includes one or more of a displaying module 310, an acquiring module 320, and a sending module 330.

The displaying module 310 is configured to display a contact formation page of first contact, the contact information page containing a transfer option corresponding to a first account of the first contact.

The acquiring module 320 is configured to, when receiving a trigger instruction triggering the transfer option, acquire an account ID of the first account, information on a local login account, and transfer information input by a user.

The sending module 330 is configured to send to a server a transfer request carrying the account ID of the first account, the information on the local login account, and the transfer information, such that the server performs transfer indicated by the transfer information from the local login account to the first account.

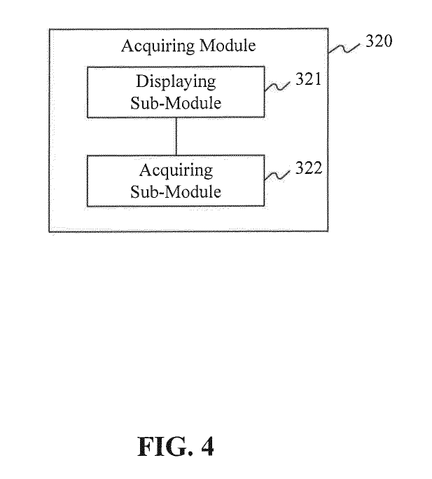

FIG. 4 is a block diagram of the acquiring module 320 (FIG. 3), according to an exemplary embodiment. Referring to FIG. 4, the acquiring module 320 includes a displaying sub-module 321 and an acquiring sub-module 322.

The displaying sub-module 321 is configured to display a pre-stored list of funding accounts bound to the local login account.

The acquiring sub-module 322 is configured to, receiving a selecting instruction selecting a first funding account in the list of funding accounts, acquire an account ID of the first funding account and an account ID of the local login account.

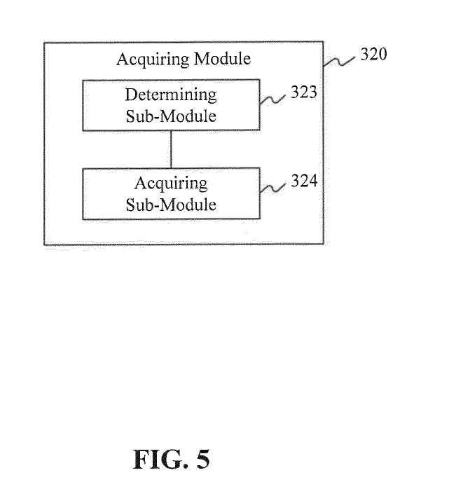

FIG. 5 is a block diagram of the acquiring module 320 (FIG. 3), according to an exemplary embodiment. Referring to FIG. 5, the acquiring module 320 includes a determining sub-module 323 and an acquiring sub-module 324.

The determining sub-module 323 is configured to determine, in the funding accounts bound to the local login account, a second funding account used most recently.

The acquiring sub-module 324 is configured to acquire an account ID of the second funding account and the account ID of the local login account.

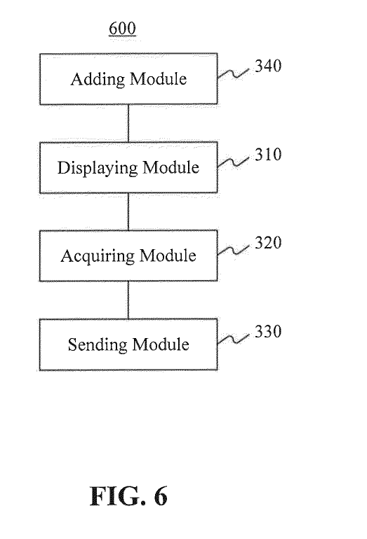

FIG. 6 is a block diagram of an apparatus 600 for requesting an account transfer, according to an exemplary embodiment. Referring to FIG. 6, the apparatus 600 further includes an adding module 340 in addition to the displaying module 310, the acquiring module 320, and the sending module 330 (FIG. 3). The adding module 340 is configured to receive a transfer account adding request sent by the server, the transfer account adding request carrying an account ID of a target account; and add a transfer option in a contact information page corresponding to the account ID of the target account.

By using the apparatus 300 (FIG. 3) and the apparatus 600 (FIG. 6), transfer to an account corresponding to a contact information page may be triggered through a transfer option on the contact information page without the need to manually input an account name of a target account by a user, thus improving transfer efficiency.

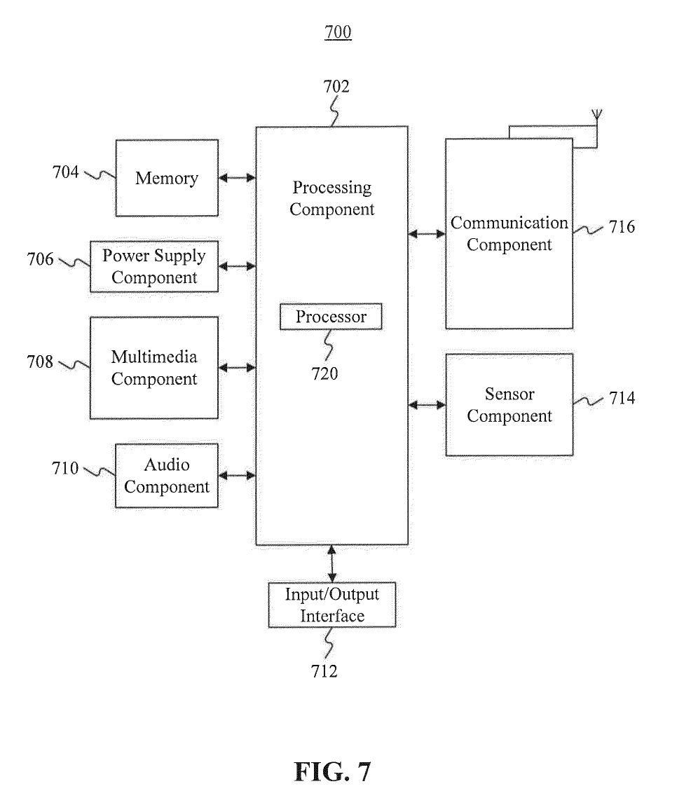

FIG. 7 is a block diagram of a terminal 700, according to an exemplary embodiment. The terminal 700 may be a mobile phone or the like.

Referring to FIG. 7, the terminal 700 may include one or more of the following components: a processing component 702, a memory 704, a power supply component 706, a multimedia component 708, an audio component 710, an input/output (I/O) interface 712, a sensor component 714, and a communication component 716.

The processing component 702 may control the overall operation of the terminal 700, such as operations associated with displaying, phone call, data communication, a camera operation, and recording. The processing component 702 may include one or more processors 720 for executing instructions to implement all or part of the steps of the method. In addition, the processing component 702 may include one or more modules facilitating interaction between the processing component 702 and another component. For example, the processing component 702 may include a multimedia module for facilitating interaction between the multimedia component 708 and the processing component 702.

The memory 704 is configured to store various types of data to support the operation on the terminal 700. Such data may include instructions of any application or method operating on the terminal 700, contact data, phonebook data, messages, pictures, videos, and the like. The memory 704 may be realized by any type of volatile or non-transitory storage equipment or combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk or compact disk.

The electric power supply component 706 may supply electric power to various components of the terminal 700. The power supply component 706 may include a power management system, one or more power sources, and other components related to generating, managing and distributing power for the terminal 700.

The multimedia component 708 may include a screen providing an output interface between the terminal 700 and a user. In sonic embodiments, the screen may include a Liquid Crystal Display (LCD) and a Touch Panel (TP). If the screen includes a TP, the screen may be realized as a touch screen to receive an input signal from a user. The TP may include one or more touch sensors for sensing touch, slide and gestures on the TP. The touch sensors not only may sense the boundary of a touch or slide move, but also detect the duration and pressure related to the touch or slide move. In some embodiments, the multimedia component 708 may include a front camera and/or a rear camera. When the terminal 700 is in operation, for example a shooting mode or a video mode, the front camera and/or the rear camera may receive external multimedia data. Each of the front camera and the rear camera may be a fixed optical lens system or may have a focal length and be capable of optical zooming.

The audio component 710 is configured to output and/or input an audio signal. For example, the audio component 710 may include a microphone (MIC). When the terminal 700 is in an operation mode such as a call mode, recording mode and a voice recognition mode, the MIC receives an external audio signal. The received audio signal may be further stored in the memory 704 or may be sent via the communication component 716.

The I/O interface 712 may provide an interface between the processing component 702 and a peripheral interface module. Such a peripheral interface module may be a keypad, a click wheel, a button or the like. Such a button may include but is not limited to: homepage button, a volume button, a start button, and a lock button.

The sensor component 714 may include one or more sensors for providing various state assessment for the terminal 700. For example, the sensor component 714 may detect an on/off state of the terminal 700 and relative positioning of components. For example, the components may be the display and the keypad of the terminal 700. The sensor component 714 may also detect change in the position of the terminal 700 or a component of the terminal 700, whether there is a touch between the terminal and a user, the orientation or acceleration/deceleration of the terminal 700, and change in the temperature of the terminal 700. The sensor component 714 may include a proximity sensor configured for detecting existence of a nearby object without physical contact. The sensor component 714 may also include an optical sensor such as a Complementary Metal-Oxide-Semiconductor (CMOS) or Charge-Coupled-Device (CCD) image sensor used in an imaging application. In some embodiments, the sensor component 714 may also include an acceleration sensor, a gyroscope sensor, a magnetic sensor, a pressure sensor or a temperature sensor.

The communication component 716 may be configured for facilitating wired or wireless communication between the terminal 700 and other equipment. The terminal 700 may access a wireless network based on a communication standard such as WiFi, 2G or 3G, or combination thereof. In an exemplary embodiment, the communication component 716 may receive a broadcast signal or broadcast related information from an external broadcast manage system via a broadcast channel. In an exemplary embodiment, the communication component 716 may also include a Near Field Communication (NFC) module for short-range communication. For example, the NFC module may be based on Radio Frequency Identification (RFID), Infrared Data Association (IrDA), Ultra-Wideband (UWB) technology, Bluetooth, and other technologies.

In an exemplary embodiment, the terminal 700 may be realized by one or more of an Application Specific Integrated Circuit (ASIC), a Digital Signal Processor (DSP), a Digital Signal Processing Device (DSPD), a Programmable Logic Device (PLD), o Field Programmable Gate Array (FPGA), a controller, a microcontroller, a microprocessor or other electronic components to implement the above described methods.

In an exemplary embodiment, there is provided a non-transitory computer-readable storage medium including instructions, such as included in the memory 704, executable by the processor 720 of the terminal 700 to implement the above described methods. For example, the non-transitory computer-readable storage medium may be a Read-Only Memory (ROM), a Compact Disc; Read-Only Memory (CD-ROM), a magnetic tape, a floppy disk and optical data storage equipment, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made Without departing from the scope thereof. It is intended that the scope of the invention only be limited by the appended claims.

What is claimed is:

1. A method for requesting an account transfer for use in a terminal, comprising:
displaying a contact information page of a first contact, wherein the contact information page contains a transfer option corresponding to a first account of the first contact;
when receiving a trigger instruction triggering the transfer option, acquiring an account identification (ID) of the first account, information on a local login account, and transfer information input by a user; and
sending, to a server, a transfer request carrying the account ID of the first account, the information on the local login account, and the e transfer information, for the server to perform transfer indicated by the transfer information from the local login account to the first account.

2. The method of claim 1, wherein the acquiring of the information on the local login account comprises:
displaying a pre-stored list of funding accounts bound to the local login account; and
when receiving a selecting instruction selecting a first funding account in the list of funding accounts, acquiring an account ID of the first funding account and an account ID of the local login account.

3. The method of claim 1, wherein the acquiring of the information on the local login account comprises:
determining, in funding accounts bound to the local login account, a funding account used most recently; and
acquiring an account ID of the determined funding account and an account ID of the local login account.

4. The method of claim 1, further comprising:
receiving a transfer account adding request sent by the server, wherein the transfer account adding request carries an account ID of a target account; and
adding a transfer option in a contact information page corresponding to the account ID of the target account.

5. An apparatus for requesting an account transfer, comprising:
a processor; and
a memory configured for storing instructions executable by the processor,
wherein the processor is configured to:
display a contact information page of a first contact, wherein the contact information page contains a transfer option corresponding to a first account of the first contact;
when receiving a trigger instruction triggering the transfer option, acquire an account identification (ID) of the first account, information on a local login account, and transfer information input by a user; and
send, to a server, a transfer request carrying the account ID of the first account, the information on the local login account, and the transfer information, for the server to perform transfer indicated by the transfer information from the local login account to the first account.

6. The apparatus of claim 5, wherein the processor is further configured to:
display a pre-stored list of funding accounts bound to the local login account; and
when receiving a selecting instruction selecting a first funding account in the list of funding accounts, acquire an account ID of the first funding account and an account ID of the local login account.

7. The apparatus of claim 5, wherein t e processor is further configured to:
determine, in funding accounts bound to the local login account, a funding account used most recently; and
acquire an account ID of the determined funding account and an account ID of the local login account.

8. The apparatus of claim 5, wherein the processor is further configured to:
receive a transfer account adding request sent by the server, wherein the transfer account adding request carries an account ID of a target account; and
add a transfer option in a contact information page corresponding to the account ID of the target account.

9. A non-transitory computer-readable storage medium having stored therein instructions that, when executed by a processor of a terminal, cause the terminal to perform a method for requesting an account transfer, the method comprising:
displaying a contact information page of a first contact, wherein the contact information page contains a transfer option corresponding to a first account of the first contact;
when receiving a trigger instruction triggering the transfer option, acquiring an account identification (ID) of the first account, information on a local login account, and transfer information input by a user; and
sending, to a server, a transfer request carrying the account ID of the first account, the information on the local login account, and the transfer information, for the server to perform transfer indicated by the transfer information from the local login account to the first account.

10. The storage medium of claim 9, wherein the acquiring of the information on the local login account comprises:
displaying a pre-stored list of funding accounts bound to the local login account; and
when receiving a selecting instruction selecting a first funding account in the list of funding accounts, acquiring an account ID of the first funding account and an account ID of the local login account.

11. The storage medium of claim 9, wherein the acquiring of the information on the local login account comprises:
determining, in funding accounts bound to the local login account, a funding account used most recently; and
acquiring an account ID of the determined funding account and an account ID of the local login account.

12. The storage medium of claim 9, wherein the method further comprises:
receiving a transfer account adding request sent by the server, wherein the transfer account adding request carries an account ID of a target account; and
adding a transfer option in a contact information page corresponding to the account ID of the target account.
